(19) United States
(12) Patent Application Publication
(10) Pub. No.: US 2010/0069227 A1
(43) Pub. Date: Mar. 18, 2010

(54) CERAMICS FOR PLASMA TREATMENT APPARATUS

(75) Inventors: Keisuke WATANABE, Kariya-shi (JP); Yukitaka Murata, Kariya-shi (JP); Shintaro Matsumoto, Kariya-shi (JP)

Correspondence Address: BUCHANAN, INGERSOLL & ROONEY PC, POST OFFICE BOX 1404, ALEXANDRIA, VA, 22313-1404, US

(73) Assignee: Covalent Materials Corporation, Shinagawa-ku (JP)

(21) Appl. No.: 12/557,656

(22) Filed: Sep. 11, 2009

(30) Foreign Application Priority Data
Sep. 12, 2008 (JP) 2008-234552

(51) Int. Cl. C04B 35/50

(52) U.S. Cl. 501/134

(57) ABSTRACT

The present invention provides ceramics for a plasma-treatment apparatus which are excellent in corrosion resistance against a halogen-type corrosive gas, plasma, etc., attain reduction in resistance, and inhibit impurity metal contamination caused by composition materials of these ceramics even in a halogen plasma process, and which can be used suitably for the component of the plasma-treatment apparatus for manufacturing a semiconductor, a liquid crystal, etc. The ceramics are used which are prepared in such a way that 3% by weight to 30% by weight of a cerium oxide relative to yttria and 3% by weight to 50% by weight of niobium pentoxide relative to yttria are added to yttria, which are fired in a reducing atmosphere to have an open porosity of 1.0% or less.

### BACKGROUND OF THE INVENTION

1. Field of the Invention

The present invention relates to ceramics for a plasma-treatment apparatus used suitably for a component of the plasma-treatment apparatus, such as etching equipment for manufacturing a semiconductor or a liquid crystal, a CVD apparatus, etc.

2. Description of the Related Art

As for a semiconductor fabricating apparatus, a component of an apparatus for an etching process, where a plasma process is dominant, a CVD film forming process, and an ashing process of removing photoresist is exposed to halogen-type corrosiveness gases, such as highly reactive fluorine and chlorine.

For this reason, ceramic materials, such as high purity alumina, an aluminum nitride, yttria, and YAG, are used for a component which is exposed to halogen plasma in the processes as described above.

Among these, in a plasma-treatment apparatus, ceramic materials, such as yttria, YAG, etc., are particularly used as the material which is highly corrosion-resistant to corrosive gas and plasma, such as halogen-type gas etc. The component whose surface is improved in corrosion resistance has been widely used. As an example of the component, there may be mentioned one in which a yttria spray-coated film is formed on aluminum or alumina ceramics.

Yttria is reacted with fluorine gas to mainly generate YF₃ (melting point: 1152° C.), and reacted with chlorine-type gas to generate YCl₃ (melting point: 680° C.). These halogenated compounds have melting points higher than those of other halogenated compounds, such as SiF₄ (melting point: −90° C.), SiCl₄ (melting point: −70° C.), AlF₃ (melting point: 1040° C.), AlCl₃ (melting point: 178° C.), etc. generated by reaction with conventionally used materials for the component of the semiconductor fabricating apparatus such as quartz glass, alumina, and an aluminum nitride etc. For this reason, even in the case where yttria is exposed to the halogen-type corrosive gas or its plasma, it demonstrates stable high corrosion resistance.

However, each of common ceramics has a volume resistivity of 10¹⁴ Ω·cm, or more and it is easy to be charged. Thus, there is a problem that a reaction product is attracted to generate particles, to cause unusual discharge, etc.

To cope with this, for the purpose of reducing the volume resistivity of yttria ceramics, a method has been proposed to add metals, metal oxides, such as a titanium oxide, a tungstic oxide, etc. which provide conductivity, metal nitrides, such as a titanium nitride etc., and metal carbides, such as titanium carbide, tungsten carbide, silicon carbide, etc. (see, for example, Japanese Patent Application Publication No. 2007-217217).

However, the ceramics to which the metals as described above are added have poor resistance to plasma, and they contain an element to be a pollutant in a semiconductor manufacturing process when they are used as the component of the plasma-treatment apparatus. Thus, they may not be desirable in some operating conditions.

Furthermore, as a device has become highly efficient and has been finely processed in these years, high vacuum high-density plasma has been employed and there has been a severer requirement for controlling the resistance to plasma or a contamination.

The contamination of a metal element may cause pollution in a semiconductor, and a degree of the influence differs for every element. For example, it is considered that Zr, Ta, etc. has a tolerance level of up to the order of 10¹¹ atoms/cm² and Na, Mg, Ca, Ti, Fe, Ni, Cu, Zn, Al, etc. has a tolerance level of up to the order of 10¹⁰ atoms/cm². Y (yttrium) may be considered as a regulation element depending on a process, and it may not be preferable that only Y has a tendency to be particularly dominant.

### SUMMARY OF THE INVENTION

The present invention arises in order to solve the above-mentioned technical problems and aims at providing ceramics for a plasma-treatment apparatus which are excellent in corrosion resistance against a halogen-type corrosive gas, plasma, etc., attain reduction in resistance, and inhibit impurity metal contamination caused by composition materials of these ceramics even in a halogen plasma process, and which can be used suitably for the component of the plasma-treatment apparatus for manufacturing a semiconductor, a liquid crystal, etc.

The ceramics for the plasma-treatment apparatus in accordance with the present invention are ceramics prepared in such a way that 3% by weight to 30% by weight of a cerium oxide relative to yttria and 3% by weight to 50% by weight of niobium pentoxide relative to the yttria are added to the yttria, which are fired in a reducing atmosphere to have an open porosity of 1.0% or less.

In this way, by adding the cerium oxide and niobium pentoxide to yttria ceramics, it is possible to attain reduction in resistance while maintaining resistance to plasma and to inhibit the impurity metal contamination caused by the composition materials of these ceramics.

It is preferable that the above-mentioned ceramics have a volume resistivity of 5×10¹¹ Ω·cm or less at 25° C.

Such low resistance ceramics can effectively inhibit the particles from taking place due to charges in the plasma process.

The ceramics for plasma-treatment apparatus in accordance with the present invention are excellent in corrosion resistance against the halogen-type gas, plasma, etc., attain reduction in resistance, and can inhibit impurity contamination caused by the composition materials of these ceramics even in a halogen plasma process, so that they can be suitably used for the component of the plasma-treatment apparatus in the process of manufacturing the semiconductor, the liquid crystal, etc., thus contributing to the improvement in the yield of semiconductor chips manufactured in the next process.

### DESCRIPTION OF THE PREFERRED EMBODIMENTS

Hereafter, the present invention will be described in detail.

Ceramics for a plasma-treatment apparatus in accordance with the present invention are ceramics prepared in such a way that a cerium oxide and niobium pentoxide are added to yttria, which are fired in a reducing atmosphere to have an open porosity of 1.0% or less.

A loading of the above-mentioned cerium oxide is between 3% by weight and 30% by weight (inclusive) relative to yttria, and a loading of the above-mentioned niobium pentoxide is between 3% by weight and 50% by weight (inclusive) relative to yttria.

In other words, the ceramics in accordance with the present invention are fired ceramics prepared in such a way that a predetermined amount of cerium oxide (CeO₂) and a predetermined amount of niobium pentoxide (Nb₂O₅) are added to yttria which has plasma-resistance.

In order to obtain the ceramics excellent in resistance against plasma, additives to yttria must not lessen the excellent resistance to plasma which yttria has, or must not contain the impurity element which is undesirable in the case of manufacturing semiconductors.

In particular, heavy metals, such as alkali metals (for example, K and Na), Ni, Cu, Fe, etc., are considered as contaminants in a semiconductor, which are not preferred.

On the other hand, it is effective to add the cerium oxide and niobium pentoxide in order to aim at reducing the volume resistivity of yttria ceramics, and to inhibit the impurity metal contamination caused by the composition materials of these ceramics in the halogen plasma process.

Further, by adding the cerium oxide and niobium pentoxide, it is possible to inhibit the outstanding contamination of Y in the semiconductor to be processed in the halogen plasma process, and to control each of the contamination amounts of Y, Ce, and Nb.

The loading of the above-mentioned niobium pentoxide is between 3% by weight and 50% by weight (inclusive) relative to yttria.

In the case where the above-mentioned loading exceeds 50% by weight, the resistance to plasma falls considerably. When using the ceramics for the component of the plasma-treatment apparatus, more particles are generated due to ceramics wearing.

On the other hand, when the above-mentioned loading is less than 3% by weight, the fall effect of the volume resistivity is not fully obtained.

When the above-mentioned loading is 15% by weight or more, a peak of Nb is detected by X-ray diffraction measurement (XRD) and the fall in volume resistivity is promoted, which is more preferred.

Further, by adding the cerium oxide to the above-mentioned ceramics, it is possible to control grain growth at the time of firing, to reduce a melting point, and to obtain a compact fired body.

It is preferable that the loading of the above-mentioned cerium oxide is between 3% by weight and 30% by weight (inclusive).

In the case where the above-mentioned loading is less than 3% by weight, the effect of adding the above-mentioned cerium oxide is not sufficiently obtained.

On the other hand, in the case where the above-mentioned loading exceeds 30% by weight, the effect of controlling the grain growth is not obtained, but segregation of the cerium oxide arises in the ceramics. This segregation part tends to be selectively etched by plasma, resulting in reduction in resistance to plasma.

The ceramics in accordance with the present invention are obtained by firing in a reducing atmosphere, such as for example, a hydrogen atmosphere, and a nitrogen atmosphere containing 5% by volume of hydrogen.

Firing in the reducing atmosphere reduces niobium pentoxide during the firing, which exists in the fired body as metal niobium and contributes to reduction in resistance.

Further, it is preferable that the above-mentioned ceramics have an open porosity of 1.0% or less.

In the case where the above-mentioned open porosity exceeds 1.0% and these ceramics are used for the component of the plasma-treatment apparatus, the etching is accelerated because of the pores, thus being prone to generation of particles.

Further, it is preferable that the above-mentioned ceramics have a volume resistivity of 5×10¹¹ Ω·cm or less at 25° C.

In the case where the above-mentioned volume resistivity exceeds 5×10¹¹ Ω·cm, these ceramics tend to be charged. When these ceramics are used for the component of the plasma-treatment apparatus, it is difficult to prevent interference to and unevenness of the plasma generation in the plasma-treatment apparatus. Further, the generation of particles is not sufficiently inhibited, either.

Such ceramics in accordance with the present invention can be obtained in such a way that added to yttria powder having a purity of 99% or more are 3% by weight to 30% by weight (inclusive and relative to the above-mentioned yttria powder) of cerium oxide powder having a purity of 99% or more and 3% by weight to 50% by weight (inclusive and relative to the above-mentioned yttria powder) of niobium pentoxide powder having a purity of 99% or more, which are fired after molding in a reducing atmosphere. A particular manufacture method will be described with reference to the following Examples.

As for each of the raw materials of yttria, the cerium oxide, and niobium pentoxide, which are the components of the ceramics in accordance with the present invention, it is preferable to use its powder having a high purity of 99% or more.

In the case where the purity is less than 99%, it is not possible to obtain the sufficiently compact ceramics. When they are used for the component of the plasma-treatment apparatus, there is a possibility of generating the particles resulting from the impurities in the raw materials.

In addition, it is possible to add sintering aids, such as a binder, to the above-mentioned raw material powder, if needed.

Further, a firing temperature is preferably 1600-1900° C., more preferably 1700-1850° C.

In the case where the above-mentioned firing temperature is less than 1600° C., many pores remain in the ceramics and it is not possible to obtain a sintered body which is sufficiently compacted.

On the other hand, in the case where the firing temperature exceeds 1900° C., exaggerated grain growth is likely to take place in a crystal grain, and its hardness falls.

The thus obtained yttria ceramics for the plasma-treatment apparatus in accordance with the present invention are excellent in resistance against plasma and inhibit the particle generation due to breakage or etching of the component. Further, since they are reduced in resistance, it is particularly possible to use them suitably for the component of the apparatus which uses the halogenated compound plasma gases, such as CCl₄, BCl₃, HBr, CF₄, C₄F₆, NF₃, SF₆, etc., and ClF₃ self-cleaning gas which is highly corrosive in a film forming process of a surface of a semiconductor wafer etc. and for the component using which is prone to be etched by the plasma of high sputtering performance using N₂ or O₂.

Hereafter, the present invention will be described more particularly with reference to Examples; however the present invention is not limited to the following Examples.

### Example 1

Yttria powder (average particle size of 1-10 μm) having a purity of 99.9% was dispersed in pure water with stirring, to which 3% by weight of cerium oxide (CeO₂) powder (average particle size of 0.5-2.0 μm) having a purity of 99.9%, and 4% by weight of niobium pentoxide (Nb₂O₅) powder (average particle size of 0.3-3.0 μm) having a purity of 99.9% were added, which were mixed and stirred with a ball mill for 5 hours, and dispersed uniformly, to prepare slurry.

This slurry was granulated with a spray dryer and the thus obtained granulation powder was pressed and molded at 1.5 t/cm² by way of cold isostatic press (CIP).

The resulting mold body was fired at 1750° C. in a hydrogen atmosphere, to obtain a ceramics fired body.

### Examples 2-6, Comparative Examples 1-6

Conditions were such that the loadings of cerium oxide, the loadings of niobium pentoxide, and firing atmospheres were as shown in Examples 2-6 and Comparative Examples 1-6 of the following Table 1. The other conditions were similar to those for Example 1, and then a ceramics fired body was prepared.

TABLE 1

| | Loading of CeO₂ | Loading of Nb₂O₅ | Firing |
|---|---|---|---|
| | (wt %) | (wt %) | Atmosphere |
| Example 1 | 3 | 4 | Hydrogen |
| Example 2 | 16 | 17 | Hydrogen |
| Example 3 | 29 | 11 | Hydrogen |
| Example 4 | 15 | 7 | Hydrogen |
| Example 5 | 18 | 40 | Hydrogen |
| Example 6 | 25 | 48 | Hydrogen |
| Comparative | 10 | 2 | Hydrogen |
| Example 1 | | | |
| Comparative | 5 | 55 | Hydrogen |
| Example 2 | | | |
| Comparative | 20 | 20 | Hydrogen |
| Example 3 | | | |
| Comparative | 2 | 5 | Hydrogen |
| Example 4 | | | |
| Comparative | 35 | 10 | Hydrogen |
| Example 5 | | | |
| Comparative | 16 | 17 | Ambient |
| Example 6 | | | Atmosphere |

Physical properties of the sintered bodies obtained in Examples and Comparative Examples above were evaluated by way of methods as shown below.

Open porosity measurement was carried out in compliance with JIS R 1634.

Resistance measurement was carried out in compliance with JIS C 2141 at room temperature (25° C.)

Further, the above-mentioned fired body was made into a shower plate which was used for plasma treatment of a silicon wafer having a diameter of 8 inches in an etching apparatus (gases used: CF₄, O₂) of an RIE system. Then, contamination of Y, Ce, and Nb on the wafer was detected, and its amount was measured.

The measurement was performed by ICP-MS and a Nb phase was checked by XRD.

The measurement results are collectively shown in Table 2.

TABLE 2

| | | | | Amount of | | |
|---|---|---|---|---|---|---|
| | Open | Volume | | Contamination | | |
| | Porosity | Resistance | | (×10¹¹ atoms/cm²) | | |
| | (%) | (Ω · cm) | Nb Phase | Y | Ce | Nb |
| Example 1 | 0.1 | 4.0 × 10¹¹ | — | 4 | 0.5 | 0.01 |
| Example 2 | 0.1 | 7.9 × 10¹⁰ | Identified | 2 | 1.0 | 0.08 |
| Example 3 | 0.1 | 2.8 × 10¹¹ | — | 2 | 2.0 | 0.05 |
| Example 4 | 0.1 | 3.2 × 10¹¹ | — | 3 | 0.7 | 0.05 |
| Example 5 | 0.2 | 5.4 × 10⁹ | Identified | 2 | 1.2 | 0.3 |
| Example 6 | 0.5 | 2.8 × 10⁸ | Identified | 2 | 3.0 | 0.4 |
| Comparative | 0.1 | 1.3 × 10¹⁵ | — | 3 | 0.8 | 0.03 |
| Example 1 | | | | | | |
| Comparative | 0.8 | 2.5 × 10⁸ | Identified | 7 | 0.3 | 3.0 |
| Example 2 | | | | | | |
| Comparative | 1.6 | 9.3 × 10¹⁰ | Identified | 6 | 5.0 | 0.8 |
| Example 3 | | | | | | |
| Comparative | 0.2 | 7.8 × 10¹¹ | — | 9 | 0.6 | 0.08 |
| Example 4 | | | | | | |
| Comparative | 0.3 | 8.0 × 10¹¹ | — | 7 | 9.0 | 0.5 |
| Example 5 | | | | | | |
| Comparative | 0.9 | 2.3 × 10¹⁶ | — | 4 | 2.0 | 0.2 |
| Example 6 | | | | | | |

As shown in Table 2, it is confirmed that each of the ceramics (Examples 1-6) in accordance with the present invention has low open porosity and its volume resistivity is also reduced. Further, in the case where it is used for the component of the plasma-treatment apparatus, it is confirmed that it is excellent in resistance to plasma and each contamination of Y, Ce, and Nb is also controlled.

What is claimed is:

1. Ceramics for a plasma-treatment apparatus, in which 3% by weight to 30% by weight of a cerium oxide relative to yttria and 3% by weight to 50% by weight of niobium pentoxide relative to yttria are added to yttria, that are fired in a reducing atmosphere, and open porosity is 1.0% or less.

2. Ceramics for plasma-treatment apparatus as claimed in claim 1, wherein volume resistivity at 25° C. is 5×10¹¹ Ω·cm or less.
